(19) United States
(12) Patent Application Publication
(10) Pub. No.: US 2008/0147481 A1
(43) Pub. Date: Jun. 19, 2008

(54) SYSTEM AND METHOD FOR ENCOURAGING USE OF A BIOMETRIC AUTHORIZATION SYSTEM

(76) Inventors: Timothy L. Robinson, Reston, VA (US); Bradford R. Schildt, Boulder, CO (US); Tennille V. Goff, Springfield, VA (US); Daniel J. Corwin, Canonsburg, PA (US); Timothy N. Watson, Washington, DC (US)

Correspondence Address: PEPPER HAMILTON LLP, ONE MELLON CENTER, 50TH FLOOR, 500 GRANT STREET, PITTSBURGH, PA, 15219, US

(21) Appl. No.: 11/831,096

(22) Filed: Jul. 31, 2007

Related U.S. Application Data
(63) Continuation-in-part of application No. 10/678,646, filed on Oct. 6, 2003.
Application No. 10/678,646 is a continuation-in-part of application No. 10/251,305, filed on Sep. 20, 2002, now Pat. No. 7,269,737.
(60) Provisional application No. 60/820,822, filed on Jul. 31, 2006.
(60) Provisional application No. 60/324,229, filed on Sep. 21, 2001.

(51) Int. Cl. G06F 17/00

(52) U.S. Cl. 705/10

(57) ABSTRACT

A system and method of providing an incentive to encourage those offering a biometric authorization system to promote its use. A biometric authorization system operator receives a reward, such as a dividend, when an individual he enrolled conducts a transaction via the biometric authorization system.

### CROSS-REFERENCE TO RELATED APPLICATIONS

This application claims priority benefit under 35 U.S.C. §119(e) from provisional application No. 60/820,822, filed Jul. 31, 2006 and is a continuation-in-part of application Ser. No. 10/678,646, filed Oct. 10, 2003, which is a continuation-in-part of application Ser. No. 10/251,305, filed Sep. 20, 2002, which claims domestic priority from provisional application No. 60/324,229, filed Sep. 21, 2001. Each above-identified application is incorporated by reference herein, in its entirety, for all purposes.

### TECHNICAL FIELD

This application relates generally to encouraging an entity to utilize a biometric authorization system. More particularly, the present invention relates to a system and method to encourage biometric authorization system operators to enroll individuals.

### BACKGROUND

Generally, merchants offer a variety of payment methods to their customers. In addition to traditional payment methods, such as cash, negotiable instruments, credit cards, and debit cards, biometric methods are also increasingly available. However, because biometric authorization systems are relatively new, merchants can be reluctant to adopt them. A merchant could view installing another payment option as undesirable, because it requires staff training as well as a monetary investment. Moreover, if consumers do not request a biometric option, a merchant could lack motivation to offer one. Even if a merchant does employ a biometric authorization system, he may have little incentive to enroll consumers or encourage use of the system instead of other payment methods. Therefore, biometric authorization system providers can have difficulty not only persuading merchants to install biometric authorization systems, but also ensuring that such systems are promoted and used.

### SUMMARY

Before the present methods are described, it is to be understood that this invention is not limited to the particular, methodologies or protocols described, as these may vary. It is also to be understood that the terminology used herein is for the purpose of describing particular embodiments only, and is not intended to limit the scope of the present disclosure.

It must be noted that as used herein, the singular forms “a,” “an,” and “the” include plural reference unless the context clearly dictates otherwise. Thus, for example, reference to a “transaction” is a reference to one or more transactions and equivalents thereof known to those skilled in the art, and so forth. Unless defined otherwise, all technical and scientific terms used herein have the same meanings as commonly understood by one of ordinary skill in the art. Although any methods and materials similar or equivalent to those described herein can be used in the practice or testing of the present invention, the preferred methods, devices, and materials are now described. All publications mentioned herein are incorporated herein by reference. Nothing herein is to be construed as an admission that the invention is not entitled to antedate such disclosure by virtue of prior invention.

In an embodiment, a method for providing a value to an entity for enrolling an individual in a biometric authorization system may include facilitating a transaction on behalf of an individual enrolled via a biometric authorization system, retrieving from a user record associated with the individual an identifier that indicates an entity that enrolled the individual in the biometric authorization system, associating the identifier with data gathered during the transaction, transmitting transaction data that includes the identifier to a processing entity, and conveying a value per an incentive guideline to the enrolling entity indicated by the identifier in accordance with an eligibility of the enrolling entity to receive the value.

In an embodiment, a method for providing an operator with an incentive to enroll individuals in a biometric authorization system may include receiving, from an enrolling operator, data including user biometric data and an enrolling operator identifier for enrolling an individual in a biometric authorization system, and storing the enrollment data in a user record associated with the user biometric data. The enrolling operator identifier may enable an identification of the enrolling operator upon a biometric authorization transaction between the individual and a transacting operator using the user record. The enrolling operator identifier may further enable the enrolling operator to receive a value for a transaction conducted by the individual through use of the biometric authorization system.

In an embodiment, a method for providing an entity with an incentive to enroll individuals in a biometric authorization system may include accessing a transaction log comprising information pertaining to one or more individuals who have participated in a biometrically authorized transaction, retrieving from the transaction log an identifier designating the entity that enrolled the individual into the biometric authorization system, utilizing the identifier to determine whether the enrolling entity is eligible for an incentive, and conveying an incentive per incentive guidelines. The identifier may be obtained from a user record associated with the individual.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof that are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a block diagram for a cross-merchant biometric authorization system according to an embodiment.

FIG. 2 illustrates a block diagram for a Point of Sale (POS) workstation according to an embodiment.

FIG. 3 illustrates a flowchart of a process for associating an operator identifier with a user record upon user enrollment.

FIG. 4 illustrates a flowchart of a process of providing operators with a dividend payment based upon enrollee-use of a biometric authorization system.

FIG. 5 illustrates a flowchart of an alternate process of providing operators with a dividend payment based upon enrollee-use of a biometric authorization system.

### DETAILED DESCRIPTION

Various embodiments of the invention are discussed in detail below. While specific implementations are discussed, it should be understood that this is done for illustration purposes only. A person skilled in the relevant art will recognize that other components and configurations can be used without parting from the spirit and scope of the invention.

Biometric authorization system (BAS) providers, such as Pay By Touch of San Francisco, Calif., have need of means to encourage potential clients to install and employ their systems. Although the BAS described herein will often be described with respect to financial transactions, this should not be construed as limiting. A BAS could be utilized for a variety of purposes, such as age-verification, physical access, virtual access, identity verification, loyalty programs, healthcare operations, membership programs, gambling, gaming, voting, or the like.

Potential BAS clients have a variety of systems available to employ. For example, merchants can accept an assortment of payment methods for financial transactions, such as cash, credit cards, debit cards, negotiable instruments, contactless tokens, gift cards, and the like. Such methods are well established and a substantial number of consumers employ them and, therefore, a merchant is motivated to accept these payment methods. Similarly, a variety of non-biometric systems exist for access, age-verification, identity verification, loyalty programs, healthcare programs, membership programs, gambling, gaming, and/or voting, and an entity requiring such a system could lack sufficient incentive to utilize a BAS instead of other options. For example, an institution could view a token-based security system as a viable choice rather than a possibly more expensive BAS.

Unlike non-biometric systems, a BAS can provide assurance that individuals utilizing the system, herein referred to as “users,” provide transaction authorization via their own unique physical characteristics. This can be beneficial to entities operating the BAS, herein referred to as “operators.” as they have empirical evidence that users have provided the necessary authorization for the relevant transaction. An operator can be an institution, such as a retailer, a government organization, or a private company, or an individual affiliated with such an entity, such as a storeowner, an employee, or a government worker.

Regardless of the benefits of a BAS, an operator might be unconvinced that the money, time, and effort required to implement such a system warrant its installation and implementation. Typically, the adoption of a new transaction system includes the installation of new equipment, such as biometric sensors, computer equipment, and the like. Although the BAS provider could provide this equipment at a reasonable rate, perhaps even complimentary, the operator staff will likely require training to use the new system. Furthermore, as such systems are relatively new, they do not have a large existing consumer base. Without consumer demand, an operator could have little cause to install and employ a BAS. This in turn creates a circular problem, in which consumers lack motivation to enroll in a BAS because few operators employ one. Furthermore, if an operator does install and employ a BAS, he may not have a reason to encourage consumers to employ it instead of existing systems. For example, a BAS operator could he subject to fees similar to those associated with non-biometric methods, and therefore could view the various systems as equal from a business perspective.

To overcome the aforementioned hindrances, a BAS provider could utilize a system and method of incentives that encourage operators to install and employ a BAS. Incentives can be based on different aspects of system use, such as enrollment, the number of BAS transactions, the value of BAS transactions, or the like. In one embodiment, an operator could receive a payment, i.e., an “enrollment dividend,” based upon the transactions of users the operator enrolled in the BAS. Such an incentive provides operators with a reason to install and promote the BAS. In particular, it encourages operators to adopt the system early in its deployment. If an operator implements the system earlier than other operators do, he could enroll more people than the succeeding operators, and thereby receive more enrollment dividends than succeeding operators.

In an embodiment, an identifier associated with the operator conducting the enrollment is associated with the enrollee's user record during the enrollee's enrollment in a BAS. The BAS provider can employ this operator identifier to determine which, if any, of the operator's enrollees have conducted a BAS transaction, and therefore, determine if the operator is entitled to an incentive. Data associated with user transactions and/or the enrolling operator can be evaluated per dividend criteria to determine the particulars of the incentive, such as the enrollment dividend amount due and the time and the method of dividend conveyance.

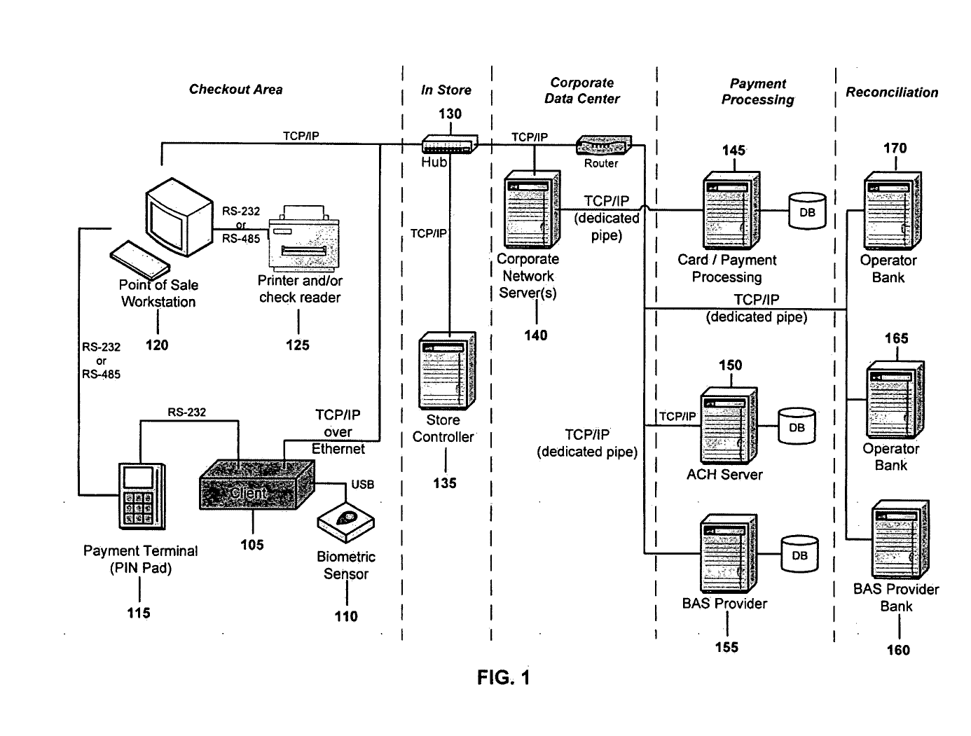

FIG. 1 depicts a block diagram for a cross-operator BAS according to an embodiment. Although described herein in terms of biometric payments, this is only one embodiment and should not be construed as limiting. As shown in FIG. 1, client hardware device 105 resides at a checkout area, such as a checkout lane, within an operator location. Multiple client hardware devices 105 can reside in a single operator environment that has multiple checkout lanes. Client hardware device 105 is attached to biometric sensor 110 for receiving biometric information from a user. Biometric sensor 110 can include any device(s) capable of accepting biometric data from a user. Client hardware device 105 is also connected to payment terminal 115, such as a PIN pad, and network hub device 135 that can serve as a hub for multiple checkout areas in an operator location.

Payment terminal 115 receives information from a user, such as via a swiped transaction card or a pass-code entered via a keypad. Payment terminal 115 is connected to POS workstation 120, such as an ECR, which processes a user transaction. POS workstation 120 is also used to forward information received from payment terminal 115 to network hub device 135. POS workstation 120 can also be attached to peripheral device 125, such as a printer, check device useful at a point-of-sale.

As discussed, network hub device 135 includes a connection to each POS workstation 120 and each client hardware device 105. Network hub device 135 is used to forward received information to server devices, such as store controller 135, corporate network server 140, payment processing servers 145 and 150 and BAS provider 155.

Furthermore, to facilitate reconciliation of enrollment dividends and transaction payments, BAS provider 155 and participating operators can be networked to various financial institutions, such as banks holding financial accounts for BAS provider 155 (BAS provider bank 160) and participating operators (e.g., Operator Bank 165 and Operator Bank 170).

BAS provider 155 can interact with store controller 135 via a communication network and one or more routers, switches and/or other telecommunications devices and a data network such as an intranet and/or the Internet. BAS provider 155 can include a database, for example, for the storage of user records containing registration biometric data and enrolling operator identifiers. BAS provider 155 determines whether a user profile match exists between biometric data and a user identifier provided by a user at the checkout area. A user identifier can be, for example, a system identification number, phone number, name, or the like and can be unique or non-unique. Additionally, a user identifier can also serve as a user group identifier that identifies a user as an affiliate of a specified group of users.

A user identifier can be presented in a variety of forms. For example, an individual can enter a user identifier via a keypad at payment terminal 115. If BAS provider 155 employs voice data, the user can speak his user identifier, such as a system identification number, to a receiver at the checkout area. In this scenario, the voice data can serve as both the user identifier and the user biometric data. Alternatively, the voice data can only serve as a convenient method to provide a user identifier. In another scenario, a user identifier can be a token. For example, a user can swipe his driver's license at the checkout area and information from the driver's license, such as a driver's license number, can he utilized to locate the user record. BAS provider 155 can then compare the received biometric data with the biometric data stored in the user record. In one scenario, the user can register more than one token to be used as a user identifier and can employ any such tokens to assist with biometric authorization. User identifier information could also be received at the checkout area wirelessly, such as via radio frequency identification (REID), infrared, Bluetooth, or the like. For example, an REID device can transmit a signal, such as a code, to assist with locating the user record. The transmitted user identifier can be used to access user information, such as biometric data, prior to the authorization, thereby increasing the efficiency of the authorization, as the stored biometric data can be located before the user provides his biometric data.

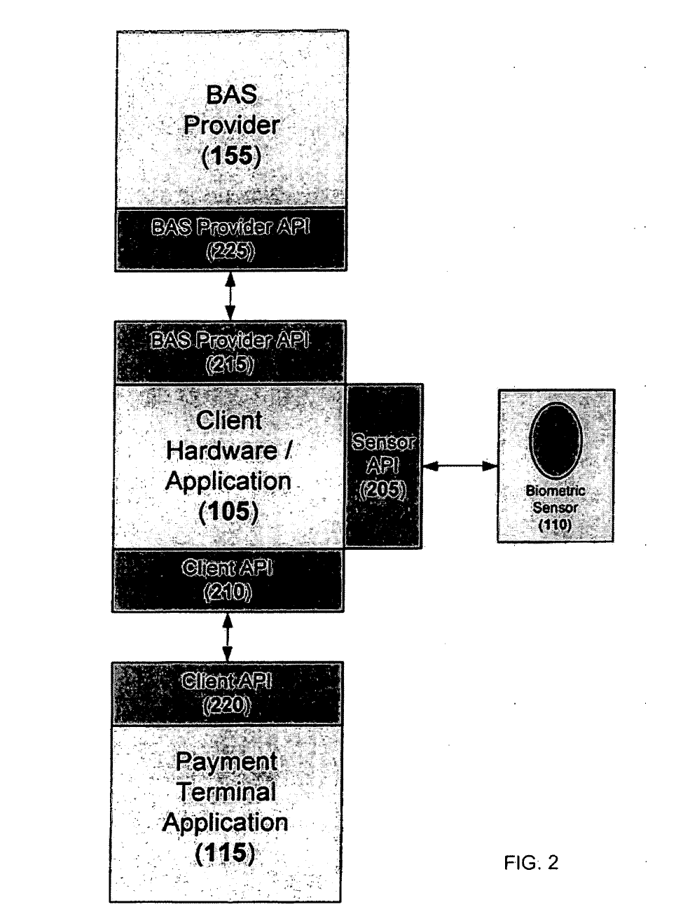

FIG. 2 depicts a block diagram depicting the software components resident on the various devices in FIG. 1, As shown in FIG. 2, client hardware device 105 includes software components based upon one or more application program interfaces (“APIs”), such as 205-215. Client hardware device 105 may include software component 205 for interfacing with biometric sensor 110 through the biometric sensor's API. Software component 205 enables client hardware device 105, for example and without limitation, to request that biometric sensor 110 activate in order to capture biometric data from a user, Client hardware device 105 can also include software component 210 for interfacing, via a commonly understood API, with complementary software component 220 of payment terminal 115. Software component 210 enables client hardware device 105 to receive requests, for example and without limitation, from payment terminal 115, capture biometric data from biometric scanner 110, receive and transmit information received from the user from payment terminal 115 to BAS provider 155, and transmit information received from BAS provider 155 (e.g., user account information) to payment terminal 115. Client hardware device 105 can also include software component 215 for interfacing, via a commonly understood API, with complementary software component 225 of BAS provider 155. Software component 215 enables client hardware device 105 to communicate with BAS provider 155, for example and without limitation, to authenticate user biometric data and to receive user record information and thereby accomplish a biometric authorization.

In general, a biometric authorization refers to an authorization in which a user, an operator, or a BAS representative, such as an employee of BAS provider 155, provides biometric data to be matched against registered biometric data. The storage location of the registered biometric data as well as the specific mechanism by which the biometric data can vary per the particulars of the BAS. For example, the biometric data taken during an authorization can be matched against registered biometric data at a location where the registered biometric data is stored or where the authorization biometric data is gathered. In addition, biometric data received during an authorization can be tested for liveness to prevent system fraud.

Furthermore, the principles of the present disclosure are not limited to using one form of biometric. For example, the biometric data referred to throughout this description can represent a biometric image (or sample) and/or a mathematical representation of the biometric images often referred to as a biometric “template.” In one example, a biometric template can represent any data format that includes feature, positional, or other representing information of characteristics of biometric data. Alternatively, a template can be a mathematical representation of more than one biometric. For example, a user template can be generated from biometric data acquired from two individual fingers, such as a thumb and index finger, or from a finger and an iris scan. The biometric data can include a fingerprint scan, an iris scan, a facial scan, a voice scan, a retinal scan, hand architecture, a DNA sample, or any other physical measurement pertaining to a user's person. User biometric data can be received by BAS provider 155 from a variety of sources, such as from the user directly or from a third-party source, such as a database, token, or the like.

For example, in one communication process flow of an architecture under FIG. 1, client hardware device 105 can be requested by payment terminal 115 to request biometric data, such as a fingerprint image, to be captured by biometric sensor 110. Client hardware device 105 receives the request and activates biometric scanner 110 to capture the fingerprint image. Client hardware device 105 receives the image from biometric scanner 110 and generates a biometric template (i.e., an extracted feature set of minutiae points) from the fingerprint image or alternatively, biometric scanner 110 generates the biometric template itself and transmits the template to client hardware device 105. Client hardware device 105 requests and receives a user identifier from payment terminal 115 and communicates the biometric template and the user identifier to BAS provider 155 (optionally using encryption and decryption algorithms). Authorization information and/or authorized payment information can be retrieved by client hardware device 105 from BAS provider 155 if the biometric template and user identifier match a user profile and thus unlocks the user's record.

For example, in a biometrically authorized cross-operator payment system, an operator processes items for purchase at POS workstation 120. Once a total purchase price has been generated POS workstation 120 sends a signal to payment terminal 115 to prompt a user for a payment method. If the user requests that biometric data be used (e.g., to obviate the necessity of providing a credit card or other payment token), payment terminal 115 communicates with client hardware device 105 to request that biometric sensor 110 activate. Payment terminal 115 can also display a prompt for the user to, for example, place a finger on biometric sensor 110. A fingerprint image is captured by biometric sensor 110 and transmitted to client hardware device 105 (or alternatively, biometric sensor 110 converts the captured fingerprint image to a template and transmits the template to client hardware device 105 for storage). Payment terminal 115 could then request the user to enter a user identifier into payment terminal 115 which payment terminal 115 then forwards to client hardware device 105. If not already generated by biometric sensor 110, client hardware device 105 then generates a biometric template based on the fingerprint image and transmits the template and the identifier to BAS provider 155 via one or more network devices, such as hub 135. The template and user identifier can be encrypted prior to transmission. BAS provider 155 then compares the template with one or more stored registration templates to determine if a match occurs. The user identifier can be used to reduce the number of stored registration templates with which the template is compared in order to decrease processing time. In one embodiment, a user identifier could be a unique number such that the template need only be compared with a single stored registration template for verification purposes. If a match occurs, BAS provider 155 sends user record information associated with the matched stored registration template to the client hardware device 105. The user record information can be encrypted prior to transmission. Client hardware device 105 can forward a representation of user record information (e.g., representations of one or more credit cards or debit cards, an enrolling operator identifier, etc.) to payment terminal 115 to be displayed to the user. Upon a selection of a particular payment option (e.g., credit card), payment terminal 115 requests client hardware device 105 to provide the associated payment account information (e.g., credit card number) and subsequently forward the payment account information to POS workstation 120. In this manner, the above process emulates, for example, a magnetic card swipe to payment terminal 115 and POS workstation 120. Normal credit processing can then be performed using POS workstation 120 to access card/payment processing server 145.

Information transferred in the BAS can be encrypted. For example, information can be encrypted at one point and sent across a non-secure connection between points or not encrypted at a point of communication and sent to the other point of communication across a secure connection. Encryption and decryption of these messages can be monitored by services provided by a security company such as VeriSign. In one scenario, as an added level of security, information internal to a terminal and which is never transmitted can also be encrypted. This prevents retrieval of sensitive information (e.g., biometric data) from a stolen terminal. In an additional embodiment, the BAS incorporates one or more anti-tampering methods by which to recognize authentic and non-authentic system requests.

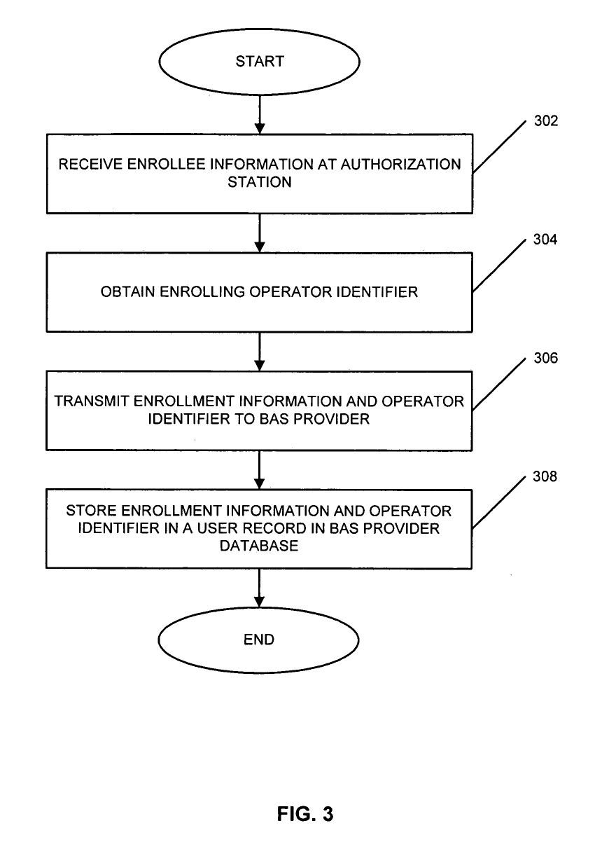

FIG. 3 illustrates a flowchart of a process for associating an operator identifier with a user record upon user enrollment. During enrollment, BAS provider 155 receives information provided by an enrollee via an authorization station (step 302). An authorization station can be any terminal networked to the BAS and provided with the necessary permission to conduct user enrollments and, as such, the particulars of an authorization station can vary by system implementation. An authorization station includes at least one biometric sensor and the necessary means for sending and receiving information to and from BAS provider 155. These stations include but are not limited to a POS workstation, vending machine, kiosk, personal computer, service desk, telephone, or wireless device. The biometric sensor could be a peripheral device or integrated into an authorization station device.

Enrollment information can include a variety of data pertinent to an individual's use of the BAS. For example, enrollment information could include biometric data (e.g., multiple fingerprint scans), financial information (e.g., credit, debit, or checking account information), contact information (e.g., mailing address, email address, phone number), and the like. The particular data requested during enrollment could vary according to a variety of factors, such as BAS provider 155 requirements, operator requirements, and the like. Additionally, the requested enrollment data could vary per the desired functionality of the BAS. For example, if the BAS is to be used for granting employees access to a facility, information pertaining to financial accounts could be unnecessary. Conversely, if the BAS is to be employed for financial transactions, particular types of identification, such as an employee's worker identification number, could be unnecessary. In general, an enrollee would be prompted to provide sufficient information to ensure BAS provider 155 could accomplish any functions that would be required in addition to verifying the user's identity. Such information could include name, address, phone number, email address, loyalty information (e.g., loyalty card number), user identifiers (system identification number, personal identification numbers, pass-codes, etc.), age information, financial data, scoring information, and the like.

During enrollment, a user could be requested to present documents or testaments to verify his identity, such as financial tokens, family information, government identification, or work identification. Furthermore, a user could provide knowledge-based, “out of wallet” information, such as his mother's maiden name, the name of his pet or childhood friend, or the like.

During enrollment. BAS provider 155 also obtains an identifier indicating which operator administered the enrollment (step 304). An operator identifier can be obtained by a variety of methods. In one scenario, information stored in an operator record could indicate the enrolling operator's identifier. The operator record could be located via a variety of identification means, such as an operator identification number, an authorization station identifier, a device identifier, an operator location identifier, biometric authorization of the individual operator overseeing the enrollment, or the like. If the individual operator will be eligible for enrollment dividends for the enrollee's transactions, he could be requested to undergo biometric authorization to confirm that he administered the enrollment. In another scenario, the enrolling operator identifier could be obtained from the authorization station itself, such as if it is stored in the memory of the station or entered at the station by the individual operator overseeing the enrollment.

An operator identifier can be any information that serves to identify the operator, such as a name and/or identification number. For example, an operator identifier could include a merchant identifier, such as “Giant Eagle.” Furthermore, an operator identifier could include a store identifier designating a particular store within a merchant chain or group, such as “store #4477.” Additionally, an operator identifier could include an employee identifier, such as an employee number and/or employee name, such as “employee #343—Wanda Smith.” If the operator identifier pertains to an individual operator, the operator identifier could include the individual's biometric data.

Utilizing a store or employee identifier could he beneficial if an operator or BAS provider 155 wishes to track enrollment practices, such as frequency regulation compliance, and the like. Moreover, enrollment incentives could be distributed throughout an operator's internal hierarchy. For example, BAS provider 155 could provide an enrollment dividend to a corporation, who could in turn provide a portion to a particular store, who could then provide a share to an individual employee. Although a particular store or employee could receive a monetary value, a corporation could instead provide another reward, such as a company trip or party, employee bonus or gift, or the like. The corporation could utilize enrollment dividend funds to sponsor such rewards.

Typically, enrollment information is sent to store controller 135 where it is compiled with the operator identifier. After the data is compiled, it is transmitted to BAS provider 155 (step 306). After BAS provider 155 receives the transmitted enrollment data and enrolling operator identifier, it stores this data in a user record in the BAS provider database (step 308).

In one scenario, BAS provider 155 and/or the operator could maintain an enrollment log. The enrollment log could be identified by the enrolling operator identifier and could list various data, such as the information provided by the user during enrollment, the date and or time of enrollment, the user identifier, and the like. The enrollment log could be used for various purposes, such as enrollment monitoring, enrollment dividend processing, and the like.

In an alternate embodiment, the operator identifier could be stored in the associated user record at a time distinct from the storage of other enrollment information. That is, a user could be enrolled and approved for system use before the enrolling operator's identifier is obtained. For example, enrollment information could be reviewed first to ensure its accuracy before crediting the enrollment to the operator. In one scenario, the operator identifier is retrieved from an enrollment log and is entered into the user record.

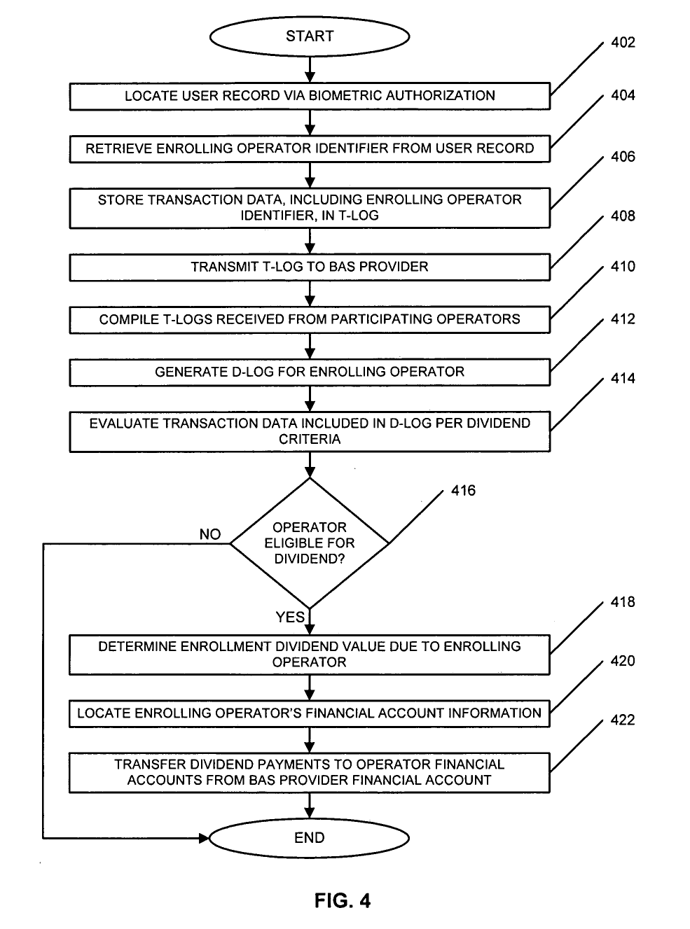

FIG. 4 illustrates a flowchart of a process of providing operators with an enrollment dividend payment for transactions conducted by users they enrolled in the BAS. During a transaction, an enrollee's user record is located via biometric authorization (step 402). As aforementioned, although the present invention is typically described in terms of a biometric payment, the present invention could be applicable to any biometric authorization process that BAS provider 155 is capable of processing.

As aforementioned, a user record can contain a variety of information, including the identifier of the enrolling operator. Once the user appropriate user record has been located, the identifier of the enrolling operator is retrieved and transmitted, along with any other user record information pertinent to the transaction, such as financial account data, to the checkout area (step 404). Depending upon the biometric authorization process employed, the enrolling operator identifier could be transmitted to the checkout area before or after the user's identity has been confirmed. For example, if the comparison of biometric data received at the checkout area with registered biometric data occurs at the BAS provider database, the enrolling operator identifier could be sent to the checkout area after a successful match. If the biometric comparison occurs at the checkout area, registered biometric data will be transmitted to the checkout area, and user record information, including the enrolling operator identifier, could be sent with it. If a successful match is ascertained at the checkout area, the transmitted user record information (including the enrolling operator identifier) could be utilized.

Once the transaction has been processed at the checkout area, transaction data, including the enrolling operator identifier, is registered as an entry in a transaction log(“t-log”) (step 406). Typically, the t-log is maintained at the client hardware device 105 or at store controller 135. A t-log entry includes a list of data relevant to the transaction, such as the enrolling operator identifier, the transacting operator identifier, a user identifier, a POS workstation identifier, a device identifier, purchase information (e.g., amount, date/time, items/services purchased, etc.), financial information, or the like. For example, if a user who enrolled at Giant Eagle initiates a BAS transaction at Wal-Mart, Wal-Mart would receive, in addition to other user record information, an indication that Giant Eagle enrolled the user in the BAS. The enrolling operator identifier, i.e., Giant Eagle's identifier, could then be associated with the current transaction by being registered in Wal-Mart's t-log.

Alternatively, the enrolling operator's identifier could be located subsequent to the transaction. For example, an enrollee's user identifier could be associated with the transaction to allow the operator or BAS provider 155 to access the user record subsequently. This could be deemed preferable if locating the enrolling operator's identifier during the transaction is deemed inefficient.

Any operator participating in the enrollment dividend program could be requested to provide t-logs to BAS provider 155. The sharing of such transaction information with BAS provider 155 facilitates the process of the current invention. Without access to t-log information from multiple operators, BAS provider 155 could not be able to determine when an enrollee has made a transaction at institutions other than the operator's. However, BAS provider 155 could limit the enrollment dividend program to a particular group of operators (e.g., a chain of merchants, a merchant group, etc.) or even to a single operator if deemed desirable by an operator or BAS provider 155.

In an alternate embodiment, a t-log could be maintained by BAS provider 155 in addition to or in place of a t-log maintained by the operator. For example, BAS provider 155 could maintain a master t-log containing data associated with any transaction run through its system.

Once a t-log has been generated, it is transmitted to BAS provider 155 (step 408). Typically, a t-log contains data from numerous transactions and is transmitted as a batch file, being sent, for example, at the close of the day or at the end of a particular period (e.g., monthly, quarterly, etc).

BAS provider 155 receives t-logs from multiple operators and compiles them (step 410). Typically, BAS provider 155 will sort the received t-logs according to enrolling operator identifiers to generate an enrollment dividend log (“d-log”) for each participating operator (step 412). That is, BAS provider 155 can extract the transaction data associated with an operator's enrollees from the compiled t-logs and assemble it as a separate record (i.e., d-log) for that enrolling operator.

Optionally, once BAS provider 155 has a list of transactions associated with a particular operator's enrollees, it evaluates the transaction data according to dividend criteria to determine if the operator is entitled to an enrollment dividend for one or more of the transactions (step 414). The evaluation could be unnecessary if the only criterion for enrollment dividend eligibility is for the operator to have enrolled the user that participated in the BAS transaction.

An enrolling operator's eligibility to receive an enrollment dividend could be based upon one or more characteristics of the operator or the enrollment the operator administered. For example, dividend criteria could evaluate the value of one or more transactions conducted by the enrolling operator, the number of transactions conducted by the enrolling operator, the number of enrollments conducted by the enrolling operator, the quality of information in an enrollee's user record, the amount of information in an enrollee's user record, the value of one or more transactions conducted by the enrollee, the number of transactions conducted by the enrollee, the time of the enrollee's enrollment, or the like. Furthermore, the size of an operator's market share could be a factor, such as if an operator is particularly dominant and would acquire an inordinate amount of enrollment dividends. For example, large retailers, such as Wal-Mart, have an exceptionally large consumer-base and BAS provider 155 could not have the economic wherewithal to provide enrollment dividends for Wal-Mart enrollees for an extended period. Even if providing enrollment dividends to a dominant operator is economically feasible, BAS provider 155 could deem this practice unattractive because it could lower the appeal of an enrollment dividend program to other operators. That is, operators with a smaller consumer-base could receive little to no benefit if a dominant operator enrolls the majority of an area's consumers.

Enrollment dividends could be provided for a specified period, such as the first six months of BAS-use, or could be provided until a limit is met. In one scenario, enrollment dividends could cease after a dividend limit is reached or after an operator has enrolled a specified number of users. BAS provider 155 could limit the amount of dividends provided in a particular period, such as per month, quarter, or year. For example, BAS provider 155 could have a $50,000 dividend cap for the each quarter. Conversely, in order to receive enrollment dividends, an operator could be required to meet certain conditions, such as an enrollee minimum, a BAS transaction quantity minimum, or a BAS transaction value minimum. An operator could forfeit his enrollment dividends for a certain time or permanently if such conditions are not met.

Enrollment dividend eligibility could be based upon transaction-specific information, such as transaction amount, the purchase of a particular product or service, the date and/or time of the transaction, and the like. For example, a financial transaction could need to meet a certain dollar amount for it to earn a dividend for the operator. This guideline could be necessary to ensure a reasonable profit for BAS provider 155. For example, if BAS provider 155 has a set amount for an enrollment dividend, such as $0.50, it could actually lose money if an enrollee conducts a transaction for less than that amount.

Once the transaction data included in the d-log is evaluated per dividend criteria, enrollment dividend eligibility is determined (step 416). No dividend is awarded if BAS provider 155 determines that dividend criteria are not met. If dividend criteria are met, BAS provider 155 determines the value of the enrollment dividend to be provided (step 418).

The value of an enrollment dividend could be based upon a variable rate (e.g., a percentage, tiered, etc.) or could be a set amount. Furthermore, BAS provider 155 could use criteria similar to those employed for enrollment dividend eligibility when determining an enrollment dividend value. For example, an operator that meets certain criteria could receive an enrollment dividend based upon a variable rate, whereas an operator that does not could receive enrollment dividends based upon a set amount.

As with dividend eligibility, the value of an enrollment dividend could be dependent upon enrolling operator characteristics or the enrollment the operator administered. For example, a dominant operator, such as Wal-Mart, could receive smaller dividends due to the quantity of enrollments it conducts, whereas a mom-and-pop operator could receive larger dividends. Furthermore, the enrollment dividend value could be based upon whether the enrolling operator has met certain conditions, such as enrolling a particular number of individuals or its enrollees conducting a certain number of transactions.

The type of data provided during enrollment could affect the value of the enrollment dividend provided to the enrolling operator. If so, the operator is motivated not only to enroll individuals into the BAS, but also to obtain substantial information when doing so. In one scenario, enrollment information based upon certain types of documents or tokens could be deemed more reliable than information based upon less secure sources. An enrollment involving information deemed highly reliable could result in the enrolling operator receiving a more valuable enrollment dividend for that user's transactions than for a user that enrolled with less reliable information. For example BAS provider 155 could view information from a financial token as less reliable than information based upon a government-issued identification token because government-issued tokens have more strenuous requirements for issuance. As another illustration, an enrollment that includes digital scans of documents or tokens, such as a negotiable instrument or identification token, could result in more valuable enrollment dividends than one that only included alphanumeric data read from such materials.

Furthermore, enrollment information that allows BAS provider 155 to access user data from third party sources could result in a superior enrollment dividend. For example, if a user provides government identification, health insurance information, or a loyalty card data, BAS provider 155 could, if allowed, access data stored at the associated source. In particular, user data associated with a private or institutional clearance system could be considered highly reliable, and therefore particularly valuable. In one embodiment, a third party institution that shares user data with an operator and/or BAS provider 155 could receive an enrollment dividend or other incentive for doing so. For example, if a user provides a health insurance identifier during enrollment. BAS provider 155 could contact the health insurance system to obtain user information. If such access is granted, the health insurance company could receive a portion of an enrollment dividend (possibly the total value) when the user is conducts a BAS transaction. BAS provider 155 could provide the third party with another incentive, such as by paying a service fee, for sharing data.

Similarly, an operator could receive a greater incentive if a user allows information within his user record to be employed for supplementary purposes. In one scenario, if during an enrollment, a user opts to allow BAS provider 155 to provide his email address or phone number to third parties, the operator could receive a larger enrollment dividend. For example, BAS provider 155, it authorized, could provide a user's address to marketers who could in turn contact the user regarding their products or services.

The value of the enrollment dividend provided to an operator could be based upon the amount of data a user provides at enrollment. For example, the minimum information requirement for enrollment in the BAS could be name, address, phone number, and biometric data. However, if a user provides more information, such as a social security number and email address, the operator could receive a greater incentive. Furthermore, the enrollment dividend associated with a user could be affected by the user record data activated for BAS usage during enrollment. For example, an operator or BAS provider 155 could desire to encourage users to employ the BAS for Automated Clearing House (ACH) transactions rather than credit or debit transactions because ACH transactions have a lower processing fee. Therefore, if at enrollment a user designates his checking account as his preferred means for BAS financial transactions, enrollment dividends associated with the user's authorization could be more valuable than those made via a credit card account.

In another scenario, the value of an enrollment dividend could be based upon the dollar value of the associated transaction or by the value of all an enrollee's BAS transactions for a period. For example, the enrollment dividends conveyed to an operator that enrolls a few users who make frequent transactions or high-value transactions could be greater than those conveyed to an operator that enrolls many users that seldom make transactions or make small transactions. Furthermore, the enrollment dividend value could be dependent upon the particular user record information a user opts to employ during the authorization (as opposed to which information, if any, was designated during enrollment). For example, during a financial transaction, a user could be presented with all the enrolled financial accounts he enrolled and the operator could receive a superior enrollment dividend if a user selects a particular financial account, e.g., his checking account, over other accounts.

In one embodiment, an enrollment dividend value could be determined by a tiered process. For example, the dividend for transactions under $100.00 could be 5% of the transaction value, while the dividend for transactions over $100.00 could be 2%. Alternatively, the dividend for a one-month period could be 5% of the transaction value of the first 1000 enrollee transactions, and 2% on any further transactions. Instead of a percentage, an enrollment dividend value could be tiered by flat amounts. For example, an enrollment dividend could be $0.05 per transaction for the first 500 transaction, $0.02 per transaction for the next 500 transactions, and so on. Additionally, BAS provider 155 could use a combination of flat amount and percentage-based dividends, such as providing a $0.02 dividend for first tier transactions, and a 3% dividend for second tier transactions.

Once the dividend value has been determined, BAS provider 155 locates the enrolling operator's financial account information (step 420). Typically, BAS provider 155 will retrieve this information from an operator record stored at the BAS provider database. As aforementioned, an operator record can be associated with the operator identifier and can contain a variety of information, including information regarding the account to which the operator desires to receive the enrollment dividend value. For example, the financial account information could comprise a checking account number and routing number, a credit card account number, or the like for an account held at operator bank 165 or operator hank 170.

BAS provider 155 then initiates an electronic transfer of funds for the enrollment dividend payment from its own financial account held at BAS provider bank 160 to the financial account of the enrolling operator, held at operator bank 165 or operator bank 170 (step 422). For example, an enrollment dividend value could be transferred from an account at BAS provider bank 160 to an account at operator bank 165 via an ACH payment.

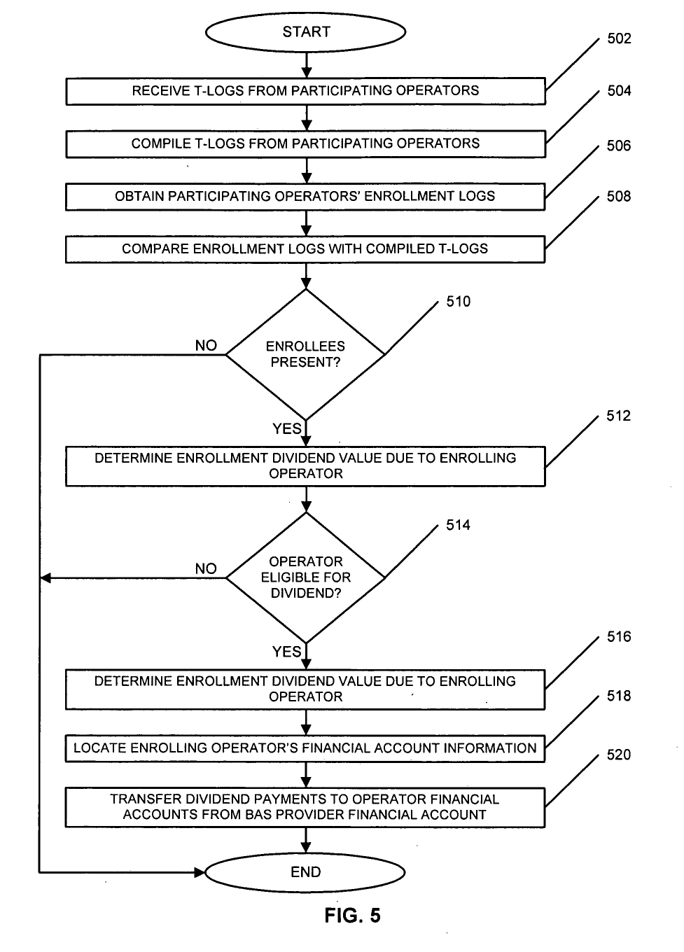

FIG. 5 illustrates a flowchart of an alternate process of providing operators with an enrollment dividend payment based upon transactions conducted by users they enrolled in the BAS. As aforementioned, although the present invention is typically described in terms of a biometric payment, it could be applicable to any biometric authorization process that BAS provider 155 is capable of processing.

BAS provider 155 receives the t-logs from participating operators (step 502). This process can similar to the one described in the description of FIG. 4, however, the transaction data included in the t-logs need not include an enrolling operator identifier, but rather user identifiers. Once BAS provider 155 has received the t-logs for all participating operators, it compiles the transaction data from the various t-logs to generate a master transaction t-log (step 504). As mentioned, each transaction entry included in the master t-log contains a user record identifier for the associated user. Additionally, each transaction entry can include more information about the particular transaction, such as a transacting operator identifier, particulars of the transaction (e.g., for a purchase, items purchased, prices, total price, etc.), and the like. Alternatively, in addition to or instead of receiving t-logs from operators, BAS provider 155 could maintain a master t-log of transactions processed through its system.

Once BAS provider 155 has generated a master t-log, BAS provider 155 accesses participating operator enrollment logs (step 506). In order to ensure accurate enrollment dividend distribution, participating operators could be required to send in enrollment logs simultaneously with t-logs. Doing so would ensure that BAS provider 155 has an up to date list of each operators' enrollees. Alternatively, or additionally, enrollment logs could be stored in the BAS provider database. Enrollment logs could be utilized to determine fraudulent practices, such as multiple user enrollments and the like, in addition to assisting in enrollment dividend processing. In one scenario, in addition to or instead of receiving enrollment logs from operators, BAS provider 155 maintains its own enrollments records.

Each participating operator's enrollment log is compared against the master t-log to determine which, if any, of an operator's enrollees are found on the master t-log and, therefore, have conducted a biometrically authorized transaction (step 508). If BAS provider 155 determines that one or more of an operator's enrollees are present (step 510), BAS provider 155 then evaluates the transaction data associated with these enrollees to determine if the enrolling operator is due a dividend per dividend criteria, as previously described (step 512).

If BAS provider 155 determines that enrolling operator's enrollees is eligible for an enrollment dividend (step 514), then BAS provider 155 determines the dividend value due to each participating operators (step 516). BAS provider 155 can use the same value determination process as described in relation to FIG. 4.

Once BAS provider 155 has determined the amount to be distributed to each participating operator, the provider retrieves financial account information for each of the operators (step 518). As previously described, BAS provider 155 typically will retrieve this information from operator records stored at the BAS provider database and located via operator identifiers.

Once BAS provider 155 has determined the necessary information for a financial transfer, BAS provider 155 initiates a monetary transfer of the enrollment dividend payment from BAS provider bank 160 to the operator's financial account (e.g., operator bank 165 or operator bank 170). Typically, the enrollment dividend payment is transferred as an ACH payment.

Alternative to the aforementioned processes, entities other than BAS provider 155 could receive the transmitted t-logs. For example, in regards to financial transactions, t-logs could be transmitted to BAS provider 155′ to card/payment processing 145, ACH server 150, or a combination thereof. In one scenario, t-logs could be first transmitted from the operator to BAS provider 155. BAS provider 155 could extract pertinent data and then transmit other data to the card/payment processing 145 and/or ACH server 150. For example, BAS provider 155 could retrieve the enrolling operator identifier and then transfer the necessary information to the appropriate credit card issuer. In another scenario, separate transaction data is transmitted from the operator to BAS provider 155 and card/payment processing 145 or ACH server 150. For example, the enrolling operator identifier could be transmitted to BAS provider 155, while financial account information and payment authorization could be sent to the card/payment processing 145. In yet another scenario, t-logs could be transmitted to the card/payment processing 145 or ACH server 150 first, which could in turn transmit pertinent information to BAS provider 155 for enrollment dividend processing. Alternatively, BAS provider 155 could handle payment processing itself and handle various processing functions internally.

Also alternative to the aforementioned processes. BAS provider need not employ operator t-logs but could rather process enrollment dividends on a per transaction basis. During a BAS transaction, BAS provider 155 could receive transaction data from the transacting operator and employ this information to process an enrollment dividend. For example, when a user initiates a BAS transaction at the checkout area, the associated transaction data could be sent to BAS provider 155 at that time (or soon after) instead of being registered in an operator t-log. BAS provider 155 could determine the operator that enrolled the user by accessing the enrollee's user record and retrieving his enrolling operator identifier stored therein. BAS provider 155 could then evaluate the transaction data per the afore-described dividend criteria and process a dividend payment accordingly either at that time or subsequently.

To profit from offering biometric services, BAS provider 155 could charge an operator a fee for handling transactions. BAS provider 155 could apply an enrollment dividend payment, such as a monthly enrollment dividend total, to the fee, thereby reducing it. If the enrollment dividend payment is larger than the fee to be assessed by BAS provider 155, the payment could be applied to a subsequent fee or could be distributed to the operator. For example, if the enrollment dividend payment due to an operator exceeds his monthly BAS fee, the excess value could be stored as a credit to be applied to a subsequent BAS fee or could be provided to the operator directly, such as in a monetary transfer to the operator's financial account at operator bank 165 or 170.

In addition to the processes previously described, enrollment dividend payments could convey via a variety of means and at various occasions. Conveyance means could be determined by BAS provider 155 and/or the operator. The particulars of conveyance will normally be established when the operator subscribes to the BAS service, although they could change later. In addition to financial account information, an operator record could contain information necessary for other conveyance methods, such as mailing address, email address, phone number, or the like. For example, enrollment dividends can be conveyed to an operator via a physical token, such as a mailed negotiable instrument or stored-value token.

Conveyance parameters could be included in the operator record, and could be adjusted by BAS provider 155 or, if allowed, the operator. In one scenario, BAS provider 155 could limit the conveyance parameters available to an operator or an operator's conveyance parameters could have to meet BAS provider 155 approval. Conveyance parameters could designate the method of conveyance, such as to apply enrollment dividends to system fees, to perform a direct deposit into a financial account, to mail a negotiable instrument, or the like. Additionally, conveyance parameters could designate which financial account(s) to credit, which mailing address payments are to be sent to, or the like, and could include preferences regarding the timing of enrollment dividend payments. An enrollment dividend value could be conveyed to multiple locations. For example, half of an enrollment dividend payment could be applied to system fees and the other half could be deposited in an operator's financial account. Conveyance could vary per the enrollment dividend value. For example, an operator could request BAS provider 155 to apply smaller dividend values to his systems fees and to transfer larger dividend values to his financial account.

In one scenario, conveyance parameters specify particular times for enrollment dividend payments, such as a particular date, day of the week, time of day, weekly, monthly, quarterly, or the like. BAS provider 155 could convey enrollment dividend payments in a batch. This batch could be sent on a regular schedule or could be transmitted once a total dividend amount has been reached. For example, once an operator's total dividends have reached $1000.00, BAS provider 155 could transmit a dividend batch to the operator's financial account or a token could be sent. Depending upon the embodiment, the operator or BAS provider 155 could determine the total dividend value required before dividend payment conveyance.

In one scenario, an operator receives enrollment dividends as a credit to a stored-value account. For example, if the operator is an individual, the stored-value account could be employed by the operator in various fashions, such as when the individual conducts financial transactions via BAS provider 155. Stored-value parameters could restrict use of the stored-value account to certain operators to encourage the individual to participate with them, For example, the stored-value account could be limited to transactions conducted with the individual's employer.

If one or more operators utilizing the services of BAS provider 155 are affiliated in some fashion, such as a merchant chain or a merchant association, they could share portions of enrollment dividends from users that they have enrolled. The actual enrolling operator could receive a greater portion than the other operators or dividends could be distributed evenly. For example, a chain of video stores could share enrollment dividends for all users enrolled within the chain, with the actual enrolling store receiving the largest portion of the dividend. Such an embodiment could be desirable because it encourages operators to promote their particular operator group, in addition to their own location. A similar program could be used to encourage operator employees to promote the BAS at their own location. For example, if a retail store offers the BAS, each employee could receive an enrollment dividend value for users enrolled at their store (with the actual enrolling employee possibly receiving the largest portion).

To encourage operators to employ the BAS further, BAS provider 155 could offer a competitive enrollment dividend program that would allow operators to appropriate users as if they had enrolled them. This program could encourage operators to not only enroll users, but also ensure that enrollees use the BAS at their locations. If a particular user conducts a certain amount of transactions with an operator, that operator's identifier could replace the enrolling operator identifier in the user's record, thereby entitling the second operator to enrollment dividends as if he had enrolled the user. For example, if a user enrolls at a 7-11 convenience store, but mainly conducts BAS transactions at Giant Eagle, Giant Eagle could acquire the rights to receive enrollment dividends. Enrollment dividend appropriation could be determined by the number of transactions conducted with an operator, the type of transactions, the value involved in the transactions, or the like. Enrollment dividend appropriation could be semi-permanent; for example, an operator could acquire dividend rights for a particular period or until another operator acquires them. Alternatively, enrollment dividend appropriation could he conducted on a per-transaction basis. An operator could be required to ensure that the specific transaction meets dividend criteria to acquire or maintain an incentive. For example, the transaction could have to meet a value minimum or be associated with a specific product, service, or activity. Alternatively, BAS provider 155 could distribute the incentives amongst one or more of the operators involved. For example, both the enrolling operator and the appropriating operator could receive enrollment dividends for a user. The dividends could be shared evenly, or the enrolling or the initial or appropriating operator could receive a larger portion. To allow small operators to be competitive with larger operators, dividend appropriation could he based upon the percentage of BAS transactions a user conducts with the operator. Alternatively, appropriation eligibility requirements could be more stringent for larger operators than for smaller ones.

In one scenario, an operator could participate with the BAS solely, or mainly, to enroll individuals and, thus, receive enrollment dividends. An enrolling operator could acquire enrollment dividends regardless of whether the operator employs the BAS for transactions other than enrollment. For example, an operator could maintain authorization stations solely to enroll users, such as enrollment kiosks. A user enrolled via one of the operator's stations could initiate BAS transactions at other operator locations, and the enrolling operator could receive dividends accordingly. Furthermore, an operator that employs the BAS for purposes beyond enrollment could also deem it profitable and convenient to utilize enrollment-only authorization stations. For example, instead of enrolling a user at a point of sale, a possibly time-consuming process, operators could request individuals enroll via such stations.

In one embodiment, a user could receive enrollment dividends for encouraging others to enroll with BAS provider 155. When enrolling, the referred individual could provide the user's information, such as his name or user identifier, and thereby indicate to BAS provider 155 that the user is entitled to an enrollment dividend. The referred individual could provide the user information when enrolling himself, or could provide it to an operator during an enrollment. Alternatively, the user could be present during the referred individual's enrollment and provide information himself, including his biometric data. In one scenario, a user could claim an enrollee as a referral after enrollment, such as by contacting BAS provider 155 and providing the enrollee's user identifier. Conversely, an enrollee can credit a user as a referrer subsequent to enrollment in a similar fashion, or both the referring user and the referred user could designate a referral subsequent to enrollment. A referral could have to be claimed within a time limit and/or a referral could be credited to the first party to do so. If an operator is involved in the enrollment process, the operator could also receive an enrollment dividend as a portion shared with the user or as a separate incentive. As with the operator-based dividends described herein, such user-based dividends could be subject to criteria, such as those indicative of a user's eligibility to receive an enrollment dividend, the value of an enrollment dividend, the method of enrollment dividend conveyance, and the like.

In one embodiment, a user can enroll himself with BAS provider 155. For example, an individual could enroll with BAS provider 155 via the Internet, such as at a BAS provider or operator website. In this situation, the user could be considered the enrolling operator, and therefore the user could be eligible for enrollment dividends. The enrolling operator identifier could be the enrollee's user identifier or could be different. If the enrollment dividend is affected by the amount or type of enrollment data provided, the user could be motivated to provide enrollment information of superior quality and/or quantity. Likewise, the user has cause to allow BAS provider 155 to utilize his information for supplementary functions (i.e., the user could be eligible for a larger enrollment dividend if he does so).

Alternatively, the provider of the enrollment means could be considered the enrolling operator, regardless of whether the authorization station at which the enrollment occurs is manned. For example, if a user enrolls via an operator website, the provider of the website could be considered the enrolling operator. If the user enrolls via a general BAS provider website, in order for an operator to receive credit as an enrolling operator, the user could provide the enrolling operator's identifier. To persuade a user to do so, the enrolling operator and/or the BAS provider 155 could offer him a reward. In one scenario, a user could purchase a device (personal computer, mobile phone, PDA, etc.) configured with software and/or hardware for BAS functionality. If the user opts to employ the BAS via the device, the manufacturer and/or provider of the device could be considered the operator and therefore could be eligible to receive enrollment dividends when a user conducts authorizations. In one scenario, the operator could be the provider of the equipment, but not the actual owner, such as when an operator leases equipment from BAS provider 155. For example, if a user enrolled via a self-service kiosk located in a merchant location, the merchant could be considered the enrolling operator even though an employee did not directly conduct the enrollment.

In one embodiment, the enrollment dividend value associated an enrollee could change if a user record is updated subsequent to enrollment. For example, a user that allowed his information to be utilized for supplementary functions at enrollment could subsequently opt out of this feature, and thus, enrollment dividends based on the user's transactions could decrease in value. Similarly, if a user who designated his checking account for financial transactions at enrollment later switches to his credit card account, the enrollment dividends associated with his authorizations could decrease in value. As another illustration, subsequent to enrollment, a user could update his user record, such as by changing financial accounts or providing more identity information, thereby increasing the value of enrollment dividends associated with his transactions. Operators could prompt users for more or better information, either during or subsequent to enrollment, in order to increase the value of their enrollment dividends. Likewise, a user that self-enrolled with BAS provider 155 could be similarly motivated to increase the robustness of his user record.

In one embodiment, BAS provider 155 could use the operator identifier to determine if the transacting operator was also the enrolling operator. If so, BAS provider 155 could process the associated transaction at a discounted processing fee rate. The processing fee discount could be provided in addition to, or in place of, enrollment dividends due to the operator. The processing fee discount could be determined by criteria, such as discussed in terms of enrollment dividends.

Although the present invention has been described chiefly in terms of incentives based upon authorizations of an operator's enrollees, BAS provider 155 could provide incentives determined by other criteria. These incentives could be offered in addition to enrollment dividends or could be offered in their stead. BAS provider 155 could impart an incentive based upon the number of enrollments an operator conducts in a particular period. For example, an operator could receive a 1% discount on a monthly BAS provider fee for each user he enrolls that month. Alternatively, an operator could receive an incentive based upon the number of authorizations conducted at any associated authorization in a set period. For example, an operator using an age-verification system could receive a monthly BAS provider fee discount if fifty or more enrollees utilized the system in a given month. Furthermore, an operator could receive an incentive if he performs a certain number of transactions regardless of whether he enrolled the associated users or not.

Likewise, BAS provider 155 could provide incentives other than monetary rewards, such as additional services, equipment, or the like. For example, BAS provider 155 could waive a fee or provide a free month of technical support. Other possible incentives could include reduced service charges, free advertising (e.g., BAS provider 155 could use the operator in its TV ads), gifts, or the like. In one embodiment, the type of incentive provided to an operator could be based upon the various criteria previously discussed. For example, an operator that acquired substantial information from a user at enrollment could receive an enrollment dividend while an operator that acquired only the minimum information could receive a small gift.

In an additional embodiment, the BAS could be utilized by an operator and/or the BAS provider 155 to monitor user behavior. For example, an operator could access information related to his enrollees to evaluate various data, such as how often they use the BAS, for what purposes, and at which locations. Operators could use such data to generate more effective advertisements and promotions, such as ones designed to acquire another operator's business or to be cooperative with a partnered operator. A user could authorize an operator and/or BAS provider 155 to monitor his behavior during enrollment or subsequently.

If the BAS is utilized for purchase transactions, stored transaction data, such as information registered in a t-log, could be employed to adjust an operator's enrollment dividends for refunds and returned payments. For example, BAS provider 155 could deem that purchases that were refunded or returned are ineligible for enrollment dividends. For example, a user could return a purchased item or a payment could be returned if a user's financial account has insufficient funds. In order to alleviate such problems, BAS provider 155 could allot enrollment dividends after a prescribed refund period has expired. For example, if a user can return an item within thirty days of its purchase, BAS provider 155 could delay processing the associated enrollment dividend until after that time. Alternatively, BAS provider 155 could employ stored transaction data to reconcile enrollment dividends with refunds and returns. For example, operators and/or payment processors could transmit refund or return payment information to BAS provider 155, which could adjust an operator's enrollment dividend value accordingly. Conversely, BAS provider 155 could notify operators and/or payment processors of refunds and returns that have been authorized via BAS provider 155. If BAS provider 155 itself handles payment processing, such reconciliation could be handled internally.

In one embodiment, BAS provider 155 can provide lesser or no dividends for improper system use, thereby ensuring operators follow proper enrollment and usage procedures. This could discourage unscrupulous operators from disregarding enrollment procedures and enrolling individuals who should not be enrolled. An operator could attempt to acquire more enrollment dividends by carelessly enrolling individuals regardless of possible problems. For example, an operator could attempt to gain enrollment dividends by enrolling unsuitable individuals, such as those inadequately documented, providing falsified identity or financial account information, and the like. If BAS provider 155 determines that the operator ignored safeguards, such as by enrolling an individual multiple times or by enrolling an individual in spite of system warnings, the operator could lose any associated enrollment dividends, and perhaps suffer further penalties.

In an additional embodiment, the BAS could be implemented as a fund raising tool. An operator and/or BAS provider 155 could participate with a third part, such a charity, to support the third party, as well as to encourage user enrollment and system use. For example, a retailer could provide a portion of its enrollment dividends to the Salvation Army. This scenario could encourage users to enroll via the participating operator instead of another operator. Furthermore, the participating operator could further benefit because enrollees are likely to perform secondary transactions in addition to enrolling. The enrollment dividend value provided to the third party could be a portion of enrollment dividend payment due to the operator or the complete value. This configuration could be permanent or could be a temporary promotion.

In one embodiment, BAS provider 155 could notify the operator of enrollment dividend (or other incentive) information. For example, BAS provider 155 could send the operator a monthly mailing or a weekly email listing the dividends the operator earned the last dividend period, as well as totals from previous periods. In another scenario, BAS provider 155 could notify the operator via telephone, either by an automated message or from a live conversation conducted with a system representative.

Operators could also view enrollment dividend and other incentive information via a network interface, such as a BAS provider website. For example, an operator could view his dividend statements, dividend rates, past dividend values, upcoming dividend information, and the like. Furthermore, a network interface could provide operators with a means to access and update their operator records. The interface could also serve as a point of contact between operators and BAS provider 155. For example, if an operator is suspected of unscrupulous behavior, further information could be gleaned via communication with the operator.

A system and method of providing an incentive to encourage those offering a biometric authorization system to promote its use has been illustrated. It will be appreciated by those skilled in the art that the system and method of the present invention can be used to encourage enrollment in and use of a BAS, It will thus be appreciated by those skilled in the art that other variations of the present invention will be possible without departing from the scope of the invention disclosed.

These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention. Therefore, the above description should not be considered to be exclusive of these other embodiments. In addition, it is to be understood that the phraseology and terminology employed herein are for the purposes of description and should not be regarded as limiting.

What is claimed is:

1. A method for providing a value to an entity for enrolling an individual in a biometric authorization system, the method comprising
facilitating a transaction on behalf of an individual enrolled via a biometric authorization system,
retrieving from a user record associated with the individual an identifier that indicates an entity that enrolled the individual in the biometric authorization system;
associating the identifier with data gathered during the transaction;
transmitting transaction data that includes the identifier to a processing entity; and
conveying a value per an incentive guideline to the enrolling entity indicated by the identifier in accordance with an eligibility of the enrolling entity to receive the value.

2. The method of claim 1, wherein the eligibility of the enrolling entity is determined by one or more of the following:
particulars of the transaction;
a value of one or more transactions facilitated by the enrolling entity;
a quantity of transactions facilitated by the enrolling entity;
a quantity of enrollments facilitated by the enrolling entity;
a quality of information stored in the user record;
a quantity of information stored in the user record;
a value of one or more transactions conducted by the user;
a quantity of transactions conducted by the user;
a scale of the enrolling entity; and
a time period.

3. The method of claim 1, wherein the value is based upon one or more of a fixed rate and a percentage of the amount of the transaction.

4. The method of claim 1, wherein the value is determined by one or more of the following:
particulars of the transaction;
a value of one or more transactions facilitated by the enrolling entity;
a quantity of transactions facilitated by the enrolling entity;
a quantity of enrollments facilitated by the enrolling entity;
a quality of information stored in the user record;
a quantity of information stored in the user record;
a value of one or more transactions conducted by the user;
a quantity of transactions conducted by the user;
a scale of the enrolling entity; and
a time period.

5. The method of claim 1, wherein the biometric authorization system is one or more of a financial transaction system, an age verification system, a physical access system, a virtual access system, a healthcare system, a membership system, and a loyalty system.

6. The method of claim 1, wherein the enrolling entity is one of an operator, the individual, or a third party.

7. A method for providing an operator with an incentive to enroll individuals in a biometric authorization system, the method comprising:
receiving, from an enrolling operator, data for enrolling an individual in a biometric authorization system, wherein the data includes user biometric data and an enrolling operator identifier; and
storing the enrollment data in a user record associated with the user biometric data, wherein the enrolling operator identifier enables an identification of the enrolling operator upon a biometric authorization transaction between the individual and a transacting operator using the user record and wherein the enrolling operator identifier enables the enrolling operator to receive a value for a transaction conducted by the individual through use of the biometric authorization system.

8. The method of claim 7, further comprising conveying a value to the enrolling operator via one or more of an electronic mechanism and a manual mechanism.

9. The method of claim 8, wherein conveying a value to the enrolling operator comprises crediting one or more financial accounts associated with the enrolling operators.

10. The method of claim 8, wherein the electronic mechanism comprises an automated clearing house transfer.

11. The method of claim 8, wherein conveying a value to the enrolling operator occurs on a periodic basis.

12. The method of claim 8, wherein conveying a value to the enrolling operator comprises applying the value to a fee charged to the enrolling operator.

13. A method for providing an entity with an incentive to enroll individuals in a biometric authorization system, the method comprising:
accessing a transaction log comprising information pertaining to one or more individuals who have participated in a biometrically authorized transaction;
retrieving from the transaction log an identifier designating the entity that enrolled the individual into the biometric authorization system, wherein the identifier is obtained from a user record associated with the individual;
utilizing the identifier to determine whether the enrolling entity is eligible for an incentive; and
conveying an incentive per incentive guidelines.

14. The method of claim 13, wherein conveying an incentive comprises conveying one or more of a discount, a value, and a gift.
